(19) United States
(12) Patent Application Publication
(10) Pub. No.: US 2010/0299654 A1
(43) Pub. Date: Nov. 25, 2010

(54) APPROACH FOR ROOT CAUSING REGRESSION BUGS

(75) Inventors: Kapil Vaswani, Bangalore (IN); Abhik Roychoudhury, Singapore (SG)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/469,850

(22) Filed: May 21, 2009

(51) Int. Cl. G06F 9/44

(52) U.S. Cl. 717/128

(57) ABSTRACT

A stable program, a new program version and a test case which passes (or fails) in the first program may be analyzed. Another new input may be found that either exhibits the similar (different) behavior as that of the test case in the first program (or second program) or follows different (similar) behavior as that of the test case in the new program version. In the first case, the trace of the test case and the new input in the second code version while in the second case, the trace of the test case and the new input in the original program are compared to produce a bug report. By reviewing the bug reports, divergences may be found and error causing code lines may be isolated.

### BACKGROUND

This Background is intended to provide the basic context of this patent application and it is not intended to describe a specific problem to be solved.

As a program evolves from one version to another, developers may inadvertently introduce defects that manifest as regressions. A test case that passes on the older, more stable version of the program may no longer pass on a newer version either because of the changes that were made or because the changes expose pre-existing defects in the code. Finding the real cause of these regressions is a manual, tedious and time consuming process.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A method that analyzes two or more versions of the application and automatically highlights the likely root cause of the failure of the test case in the new version of the program is disclosed. The method may start with a stable program, a new program version and a test case which passes (or fails) in the first program. Another new input may be found that either exhibits the similar (different) behavior as that of the test case in the first program (or second program) or follows different (similar) behavior as that of the test case in the new program version. In the first case, the trace of the test case and the new input in the second code version while in the second case, the trace of the test case and the new input in the original program are compared to produce a bug report. By reviewing the bug reports, divergences may be found and error causing code lines may be isolated.

### BRIEF DESCRIPTION OF THE DRAWINGS

FIG. 1 is an illustration of a computing device;

FIG. 2 is an illustration of method of determining root causing error in two versions of an application; and

FIG. 3 is an application flow in a first version and a second version

FIG. 4 is an illustration of two version of code and varying results;

FIG. 5 is an illustration of two version of code and varying results; and

FIG. 6 is an illustration of a trace matching method.

### SPECIFICATION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

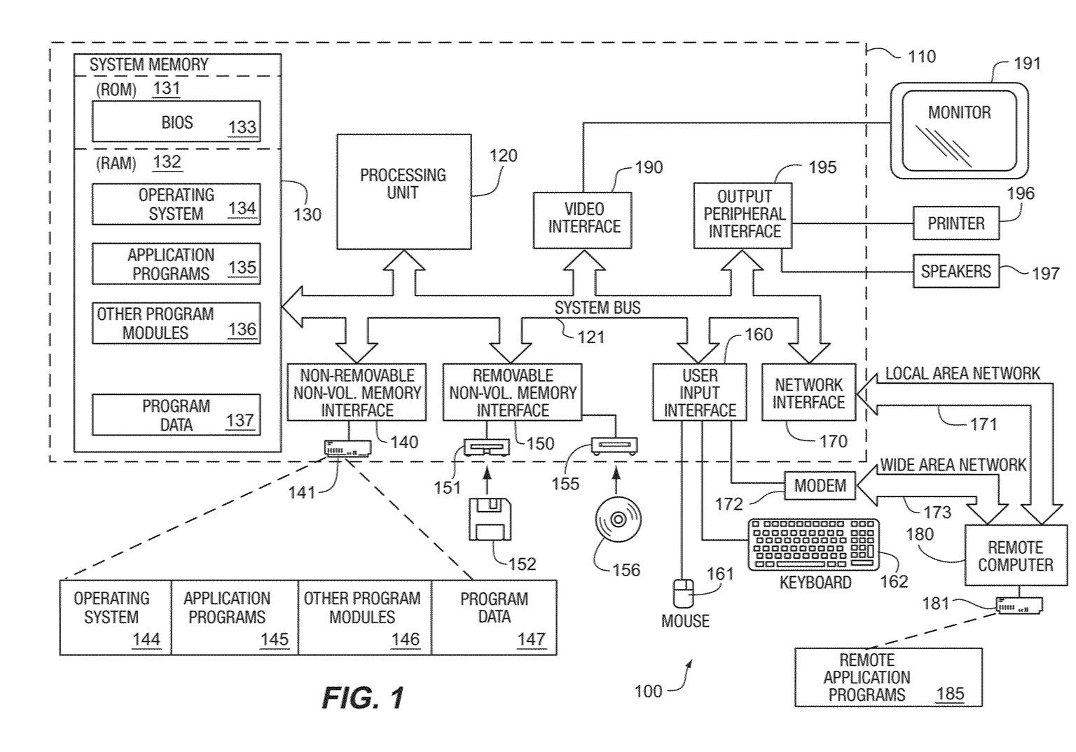

FIG. 1 illustrates an example of a suitable computing system environment 100 that may operate to execute the many embodiments of a method and system described by this specification. It should be noted that the computing system environment 100 is only one example of a suitable computing environment and is not intended to suggest any limitation as to the scope of use or functionality of the method and apparatus of the claims. Neither should the computing environment 100 be interpreted as having any dependency or requirement relating to any one component or combination of components illustrated in the exemplary operating environment 100.

With reference to FIG. 1, an exemplary system for implementing the blocks of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120.

The computer 110 may operate in a networked environment using logical connections to one or more remote computers, such as a remote computer 180, via a local area network (LAN) 171 and/or a wide area network (WAN) 173 via a modem 172 or other network interface 170.

Computer 110 typically includes a variety of computer readable media that may be any available media that may be accessed by computer 110 and includes both volatile and nonvolatile media, removable and non-removable media. The system memory 130 includes computer storage media in the form of volatile and/or nonvolatile memory such as read only memory (ROM) 131 and random access memory (RAM) 132. The ROM may include a basic input/output system 133 (BIOS). RAM 132 typically contains data and/or program modules that include operating system 134, application programs 135, other program modules 136, and program data 137. The computer 110 may also include other removable/non-removable, volatile/nonvolatile computer storage media such as a hard disk drive 141 a magnetic disk drive 151 that reads from or writes to a magnetic disk 152, and an optical disk drive 155 that reads from or writes to an optical disk 156. The hard disk drive 141, 151, and 155 may interface with system bus 121 via interfaces 140, 150.

A user may enter commands and information into the computer 110 through input devices such as a keyboard 162 and pointing device 161, commonly referred to as a mouse, trackball or touch pad. Other input devices (not illustrated) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device may also be connected to the system bus 121 via an interface, such as a video interface 190. In addition to the monitor, computers may also include other peripheral output devices such as speakers 197 and printer 196, which may be connected through an output peripheral interface 190.

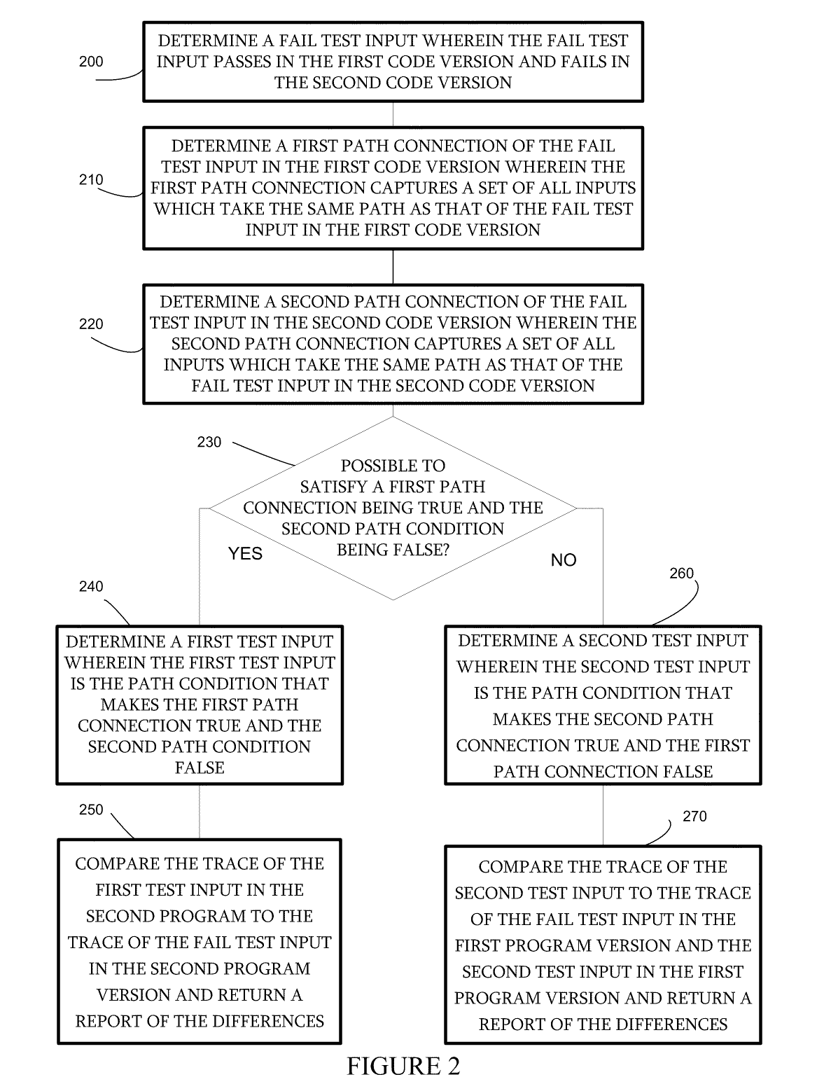

FIG. 2 illustrates a method of determining error causing code sections between a first code version P1 and a second code version P2. When moving from a first code version 305 to a second code version 310, undesired changes may occur. Sometimes, these changes may uncover defects that were in the original version of the code and some changes may create new defects in the new version of the code. Trying to isolate the source of the defect between code sections has long been a challenge. In addition, code versions are often tested with drastically different inputs to look for errors, not with inputs with small changes that would assist isolating problems between versions.

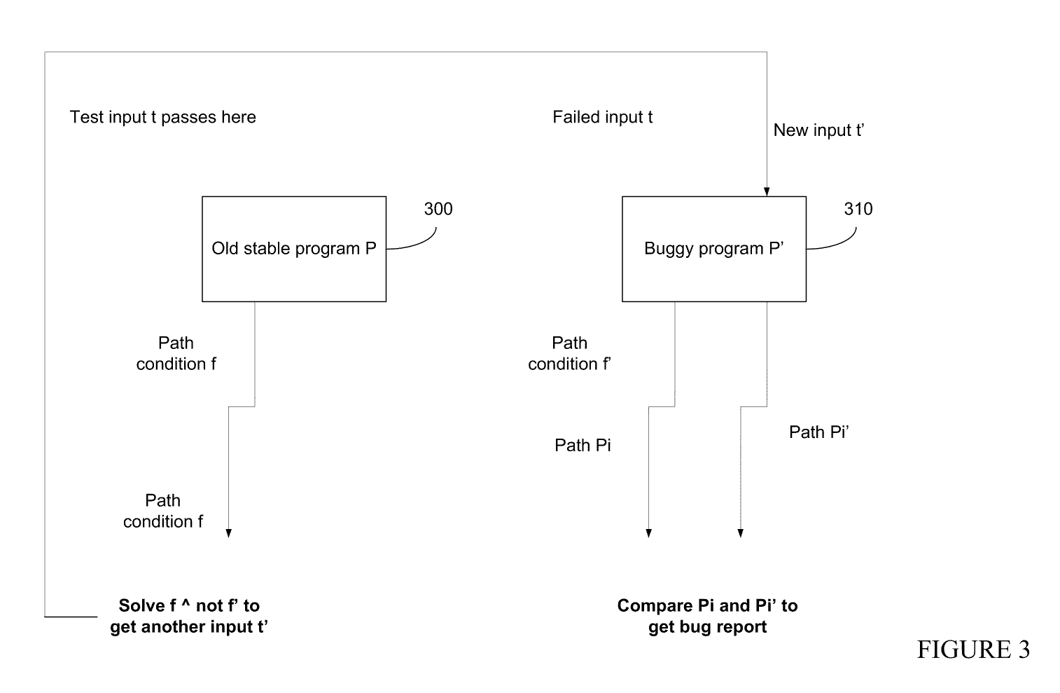

In FIG. 3, a basic idea behind the approach is illustrated. At a high level, a stable program version P, a changed version P′, and a test-case t which passes (fails) in P (P′), the trace produced by t in P′ is compared with the trace produced by another test-case t′in P′. A test case t′may be generated that satisfies the following properties:

t′ and t follow the same program path in P.
t′ and t follow different program paths in P′.

Such a test t′ may be found by computing path conditions of t in P and P′. As t′ and t follow the same program path in P—the behavior of t, t′are supposed to be “similar” in P (the stable program version). However, since t, t′follow different program paths in P′—their behaviors “differ” in P′ (the buggy new version). By computing and highlighting the differences in their behavior, the possible causes of the error are highlighted exposed by test-case t. A pictorial description of the debugging method appears in FIG. 1.

At block 200, a fail test input (t) may be determine, The failing test input may be a code input that passes in the first code version 300 and fails in the second code version 310. For example, a test case that causes a null memory pointer exception would not pass. By failing, the code version 300 310 may cause an error or other undesirable or unplanned result.

At block 210, a first path condition of the failing test input in the first code version 300 may be determined. The first path condition may capture a set of all inputs which take the same path as that of the fail test input (t) in the first code version; for example, in FIG. 3, if there is an error in code section d, all the possible ways to get to code section d may be part of the first path condition.

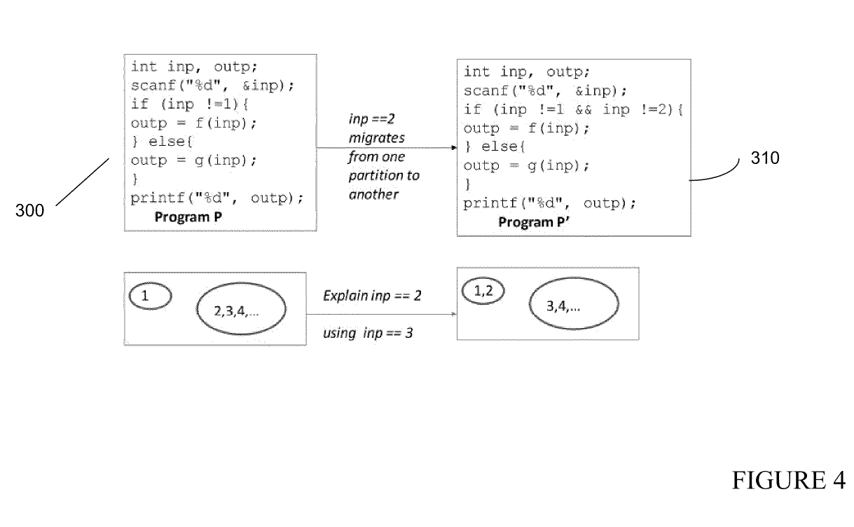

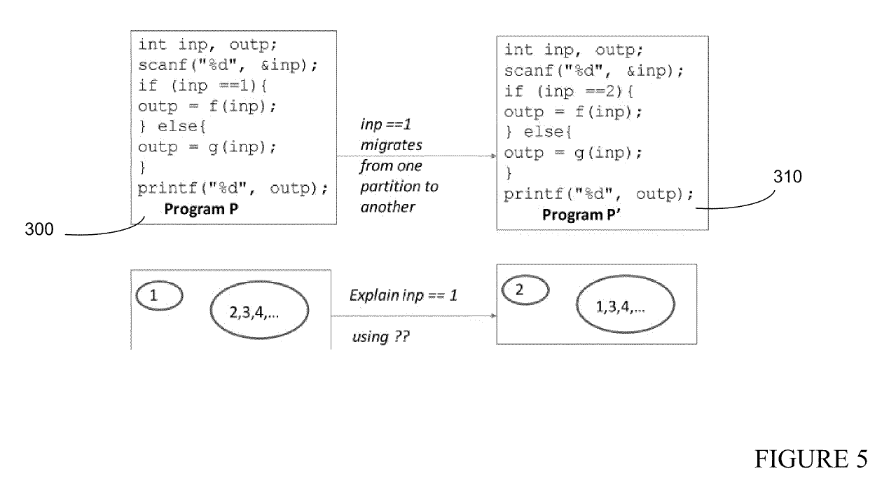

As an example, in FIG. 3, consider a program fragment with a integer input variable inp—the program P in FIG. 4. This is the old program version. Note that f, g are functions invoked from P. The code for f,g is not essential to understanding the example, and hence not given. Suppose the program P is slightly changed to the program P′. in FIG. 5 thereby introducing a “bug”. Program P′is the new program version. As a result of the above “bug”, certain test inputs which passed in P may fail in P′. One such test input is inp==2 whose behavior is changed from P to P′. Now suppose the programmer faces this failing test input and wants to find out the reason for failure. One embodiment of the method may work as follows.

Program P may be run program for test case inp==2, and the resultant path condition f may be calculated, a formula representing set of inputs which exercise the same path as that of inp==2 in program P. In this example, the path condition f is inp≠1.

Program P′may also be run for test case inp==2, and the resultant path condition f′ may be calculated, a formula representing set of inputs which exercise the same path as that of inp==2 in program P′. In our example, the path condition f′ is (inp≠1̂inp≠2).

The formula f̂.f″ may be solved. Any solution to the formula is a test input which follows the same path as that of the test case inp==2 in the old program P, but follows a different path than that of the test case inp==2 in the new program P′. In this example f̂.f′ is

inp≠1̂(inp≠1̂inp≠2)

A solution to this formula is any value of inp other than 1, 2—say inp==3.

The trace of the test case being debugged (inp==2) in program P′ may be compared with the trace of the test case that was generated by solving path conditions, namely (inp==3). By comparing the trace of inp==2 with the trace of inp==3 in program P′ the method may find that they differ in the evaluation of the branch inp !=1 && inp !=2. Hence this branch is highlighted as the bug report—the reason for the test case inp==2 failing in program P′.

It is assumed that P and P′ have the same input space, and the partitioning of program inputs based on paths are partitioned—two inputs are in the same partition if they follow the same path. Then, as P changes to P′ certain inputs migrate from one partition to another. FIG. 4 illustrates this partitioning and partition migration. If the change P.P′is considered, the behavior of the failing input inp==2 is explained by comparing its trace with the trace of inp==3, an input in a different partition in the new program P′. Furthermore, inp==3 and inp==2 lie in the same partition in the old program P.

Sometimes, given two program versions P, P′ and a test input t which passes (fails) in P (P′)—a meaningful alternate input may not be found by solving f̂.f. Consider the example programs in FIG. 5 and the associated input space partitioning. In this case, there are at least two inputs which migrate across partitions in changing the program from P to P′. Suppose the task is explaining the behavior of inp==1.

The path condition f of inp==1 in P is inp=1 while the path condition f′ of inp==1 in P′ is inp≠2. So, in this case f̂.f′ is

inp=1̂(inp≠2)
which is un-satisfiable. The reason is simple, there is no input which shares the same partition as that of inp==1 in the old program.

The solution to the above dilemma lies in conducting our debugging in the old program version. If the method may find that f̂.f′ is un-satisfiable, the method may solve f′̂.f. This yields an input t′ which takes a different path than that of the failing input t in the old program version. The traces of t and t′ may be traced in the old program version to find the error root cause.

In our example FIG. 3, f′̂f is

inp≠2̂(inp=1)

This yields solutions which are different from 1 and 2, say inp==3. The trace of inp==3 may be compared with the trace of inp==1 in the old program. This highlights the branch inp==1 in the old program, as bug report.

The reader may think the above situation as odd—when a test case fails in a new program, a fragment of the old program may be returned as bug report. But, indeed this is the thesis—the bug report returned by the debugging method will help the application programmer comprehend the change from the old program to the new program, rather than helping him/her comprehend the new program. Of course, given a branch in the old program as bug report, it can be related to a branch in the new program by dependence preserving program alignment methods. Note that the method does not espouse program change comprehension via a full-scale static alignment of program versions. Only after a bug report is generated via the dynamic analysis, if the bug report refers to the old program—one can relate the bug report to the new program via such program alignment.

At block 220, a second path condition of the failing test input in the second code version 310 may be determined. The second path condition 310 captures a set of all inputs which take the same path as that of the fail test input (t) in the second code version 310. For example, in FIG. 3, if there is an error in code section d′, all the possible ways to get to code section d′may be part of the second path condition.

At block 230, it may be determined whether the condition that the first path condition being true and the second path condition being false can be satisfied. In other words, it may be determined whether there an input that will cause no errors, unwanted or undesired consequences in the first code section but would cause an error or an unwanted or undesired consequence in the second code section.

The formula f̂f′ (f and not f′) may then be solved by any constraint solver. For example, Z3 is an automated satisfiability checker for typed first-order logic with several built in theories for bit-vectors, arrays etc. The Z3 checker serves as a decision procedure for quantifier-free formula. Indeed this is the case for us, since our formulas do not have universal quantification and any variable is implicitly existentially quantified.

At block 240, if there is an input that will cause no errors, unwanted or undesired consequences in the first code section but would cause an error or an unwanted or undesired consequence in the second code section, a first test input may be determined. In one embodiment, the first test input may be the input that makes the first path condition true and the second path condition false. Of course, other artifacts are possible and are contemplated. As alternative to path conditions, we may consider code artifacts such as the collection of branches or decisions in a code section 300 310.

### Generation of Alternate Input

The method may actually perform a concolic (concrete+symbolic) execution of t on each of the program versions. In other words, during the concrete execution of t along a program path p, the method may also accumulate a symbolic formula capturing the set of inputs which exercise the path p. This symbolic formula is the path condition of path p, the condition under which path p is executed. It is worth mentioning that the path conditions are calculated on the program binary, rather than the source code. Such an approach may also be referred to as symbolic expression which may entail proceeding through a code section, collecting all conditions (or branches or decision) in the code section into an expression and submitting the expression to the code version. Symbolic execution is known generally but has not been used for debugging purposes.

One issue that arises in the accumulation of path conditions is their solvability by constraint solvers. For example, for a program branch if (x*y>0), the method may accumulate the constraint x*y>0 into the path condition. This may be problematic if the constraint solver is a linear programming solver. In general, the method may have to assume that the path condition calculated for a path p is an under-approximation of the actual path condition. Usually such an under-approximation is achieved by instantiating some of the variables in the actual path condition. For example, to keep the path condition as a linear formula, the method may under-approximate the condition x*y>0 by instantiating either x or y with its value from concrete program execution.

Recall that, the method may need to solve the formula f̂f′ for getting an alternate program input, where f (f′) is the path condition of the test input t being examined in the old (new) program version. As mentioned earlier, the computed f, f′ will be an under-approximation of the actual path conditions in old/new program versions. Let f computed (f′ computed) be the computed path conditions in the old (new) program versions. Thus fcomputed=>f f′ computed=>f′

As a result, the method may have:

(fcomputed̂.f′computed) ≠>(f.̂f′)

Thus, the method may not be able to ensure that fcomputed̂f′computed is an under-approximation of f.̂f′. Hence, after solving fcomputed̂f′computed if the method finds a solution t′, the method may also perform a validation on t′. The validation will ensure the methods' required properties, namely: t, t′. follow same (different) program paths in old (new) program version. Such a validation can be performed simply by concrete execution of test inputs t, t′in the old and new program versions.

Similarly, if the method needs to solve the formula f′̂f (that is if the formula f̂f′ is found to be unsatisfiable), the method may perform a validation of the test input obtained by solving f′̂f.

At block 250, the trace of the first test input in the second code version 310 may be compared to the trace of the failing test input in the second code version 310. The first test input may cause errors in the second code version 310. The failing test input also may cause errors the second code version 310. This comparison of the trace of the first test input and the failing test input may be returned in a report of the differences between the traces. The report may be a bug report, and may be at an assembly level that is reverse translated into a source level bug report for the second code version 310. The source level bug report may list possible places to look for an error causing code in the second code version 310. Trace comparison may proceed by employing string alignment methods (which are widely used in computational biology for aligning DNA sequences) on the traces and the branches which cannot be aligned appear in the bug report.

The two test inputs whose traces are generated may be

(a) the test input under examination t, and (b) the alternate test input t′generated in the first phase.

Comparison of program traces have been widely studied in soft-ware debugging, and various distance metrics have been proposed. Usually, these metrics choose an important characteristic, compute this characteristic for the two traces and report their difference as the bug report. Commonly studied characteristics (for purposes of debugging via trace comparison) include:

set of executed statements in a trace,
set of executed basic blocks in a trace,
set of executed acyclic paths in a trace,
sequence of executed branches in a trace,
and so on. A sequence-based difference metric (which captures sequence of event occurrences in an execution trace) may distinguish execution traces with relatively greater accuracy. In the method, a difference metric may be used focusing on sequence of executed branches in a trace, but it may be applied for traces at the assembly code (instruction) level.

1. while (lin[i] != ENDSTR) {
2. m= ...
3. if(m>=0) {
4. ...
5. lastm = m;
6. }
7. if((m==−1)||(m==i)){
8. ...
9. i=i+1;
10. }
11. else
12. i=m;
13. }
14. ...
15. }
In P’, line 3 is
3. If (m >=0) && (lastm !=m)

The resulting output may be as follows:

| T | T′ |
|---|---|
| 1 | 1 |
| 2 | 2 |
| 3 | 3 |
| 4 | 7 |
| 5 | 8 |
| 7 | 9 |
| 8 | |
| 9 | |

After collecting and comparing the traces at the instruction level, the method may report back the instructions appearing in the “difference” between the two traces at the source-code level for the convenience of the programmer.

The method may thus represent each trace as a string of instructions executed. In practice, the method may need not record every instruction executed; storing the branch instruction instances (and their outcomes as captured by the immediate next instruction) suffices. Given test inputs t and t′, a comparison of the traces for these two inputs is roughly trying to find branches which are executed with similar history in both the traces, but are evaluated differently. In order to find branches with similar history in both the traces, the method may employ string alignment algorithms widely employed on DNA/protein sequences in computational biology. These methods produce an alignment between two strings essentially by computing their “minimum edit distance”.

To illustrate the workings of the method of trace comparison, consider the program fragment in paragraphs 64-78. This program may be from a faulty version of the replace program from Software-artifact infrastructure repository, simplified here for illustration. This piece of code changes all substrings s1 in string lin matching a pattern to another substring s2. Here variable i represents the index to the first unprocessed character in string lin, variable m represents the index to the end of a matched substring s1 in string lin, and variable lastm records variable m in the last loop iteration. The bug in the code lies in the fact that the branch condition in line 3 should be if (m>=0) && (lastm !=m). At the ith iteration, if variable m is not changed at line 2, line 3 is wrongly evaluated to true, and substring s2 is wrongly returned as output, deemed by programmer as an observable “error”.

An execution trace exhibiting the above-mentioned observable error will execute .1, 2, 3, 4, 5, 7, 8, 9. in the ith loop iteration. An execution trace not exhibiting the error (i.e., a successful execution trace) will execute .1, 2, 3, 7, 8, 9. in the ith loop iteration. Now, consider the alignment of these two execution traces—for simplicity the alignment of their ith loop iterations may be shown.

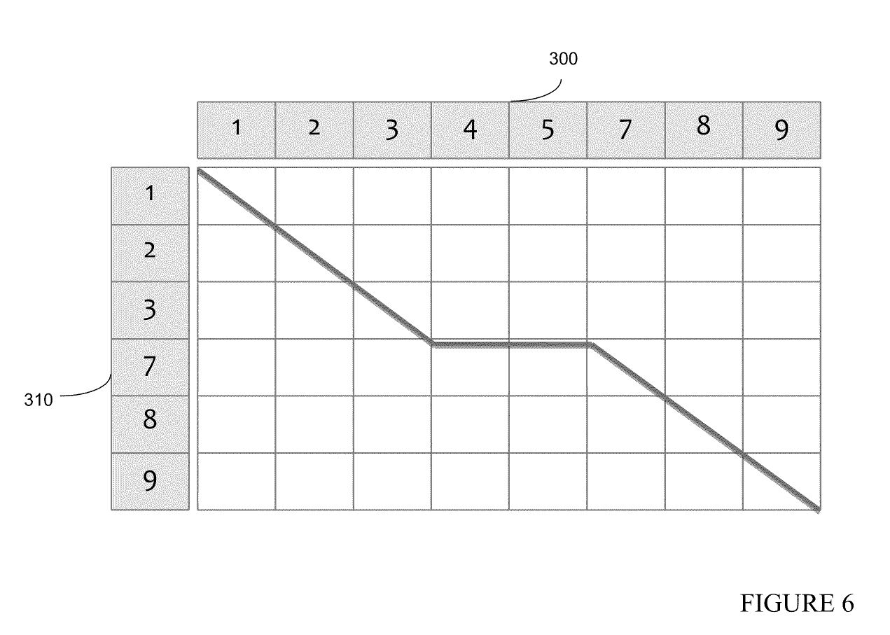

The string alignment method may compute the smallest edit distance between the two traces—the minimum cost edits with which one string can be transformed to another. The edit operations are in-sert/delete/change of one symbol, and the cost of each of these op-erations need to be suitably defined. Conceptually this is achieved by constructing a two-dimensional grid such as in FIG. 6 The rows (columns) of the grid are the symbols recorded in the first 300 (second 310) execution trace.

Finding the best alignment between the traces now involves finding the lowest cost path from the top-left corner of the grid to the bottom right corner of the grid. In each cell of the grid, the method has a choice of taking a horizontal, vertical or diagonal path (vertical) path means insertion (deletion) of a symbol in the first execution trace, while a diagonal path means comparing the corresponding symbols in the two traces. If the method has to insert/delete a symbol the method may incur some penalty (say a>0). Moreover, if the method compares two symbols of the two traces and record a mismatch the method may also incur some penalty (say B where typically β>a). Of course, if the method compares two symbols of the two traces and record a match, zero penalty is incurred. A least-cost alignment then corresponds to finding the path with minimum penalty from the top left corner to bottom right corner of the grid.

Note that the string alignment methods from computational biology (which the method may use) often use complicated cost functions to capture the penalties of inserting/deleting/changing a symbol. However, in the trace comparison, the method may use the following: (i) cost of inserting a symbol=cost of deleting a symbol=a (a positive constant), and (ii) cost of changing a symbol=β (another positive constant greater than alpha).

FIG. 6 shows the two-dimensional grid for the two traces (1, 2, 3, 7, 8, 9) and (1, 2, 3, 4, 5, 7, 8, 9) taken from the program in Figure in paragraphs 0064-0079. A least-cost alignment found for these two traces (assuming a=1, β=2) is shown in the figure via arrows. This corresponds to the following (expected) alignment.

1 2 3 _ _{—} 7 8 9
1 2 3 4 5 7 8 9

Having found the alignment between two traces, the bug report construction simply records the aligned branches in the two traces which have been evaluated differently. The sequence of these branches are presented to the programmer as bug report. In the preceding example, only the branch 3 may appear in the bug-report, thereby highlighting the error root-cause.

At block 260, if the decision at block 230 was no (the condition that the first path condition being true and the second path condition being false can not be satisfied), a second test input may be determined. The second test input may be an input that makes the second path condition true and the first path condition false. At block 270, the trace of the second test input may be compared to the trace of the fail test input in the first code version 300 and the second test input in the first code version 300. The second test input may cause errors in the first code version 300 and the fail test input may also cause errors in the first code version 300. This comparison may be returned in a report of the differences between the traces of the second test input and the fail test input in the first code version 300.

In conclusion, the detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

1. A method of determining error causing code sections between a first code version and a second code version comprising:
determining a fail test input wherein the fail test input passes in the first code version and fails in the second code version;
determining a first path condition of the fail test input in the first code version wherein the first path condition captures a set of all inputs in the first code version which take the same path as that of the fail test input (t) in the first code version;
determining a second path condition of the fail test input in the second code version wherein the second path condition captures a set of all inputs in the second code version which take the same path as that of the fail test input (t) in the second code version;
determining whether a condition that the first path condition being true and a second path condition being false can be satisfied;
if there is an input that makes the first path condition be true and the second path condition be false,
and
comparing a trace of the first test input in the second code version to a trace of the failing test input in the second code version and return a report of differences between the trace of the first test input in the second code version to the trace of the fail test input in the second code version; and
if there is not an input that makes the first path condition be true and the second path condition be false,
determining a second test input wherein the second test input makes the second path condition true and the first path condition false; and
comparing a trace of the second test input to a trace of the failing test input in the first code version and the second test input in the first code version and return a report of the differences between the trace of the second test input to the trace of the fail test input in the first code version and the second test input in the first code version.

2. The method of claim 1, further comprising using symbolic execution in the first code version and the second code version.

3. The method of claim 2, wherein symbolic execution comprises
proceeding through a code section;
collecting all conditions in the code section into an expression; and
submitting the expression to the first code version or the second code version.

4. The method of claim 3, wherein the condition is a branch in the code section.

5. The method of claim 1, wherein comparing the trace of the first test input in the second code version to the trace of the fail test input in the second code version returns a bug report at an assembly level that is reverse translated into a source level bug report for the second code version.

6. The method of claim 5, wherein the source level bug report for the second code version comprises second code version code sections that should be reviewed for causing errors in the second code version.

7. The method of claim 1, wherein comparing the trace of the second test input to the trace of the fail test input in the first code version and the second test input in the first code version returns a bug report at an assembly level that is reverse translated into a source level bug report for the first code version.

8. The method of claim 7, wherein the source level bug report for the first code version comprises first code version code sections that should be reviewed for causing errors in the first code version.

9. A computer storage medium comprising computer executable instructions for physically configuring a processor for determining error causing code sections between a first code version and a second code version, the computer executable instructions comprising computer executable instruction for:
determining a fail test input (t) wherein the fail test input passes in the first code version and fails in the second code version;
determining a first path condition of the fail test input in the first code version wherein the first path condition captures a set of all inputs in the first code version which take the same path as that of the fail test input (t) in the first code version;
determining a second path condition of the fail test input in the second code version wherein the second path condition captures a set of all inputs in the second code version which take the same path as that of the fail test input (t) in the second code version;
determining whether a condition that the first path condition being true and a second path condition being false can be satisfied;
if there is an input that makes the first path condition be true and the second path condition be false,
determining a first test input wherein the first test input is a path condition that makes the first path condition true and the second path condition false; and
comparing a trace of the first test input in the second code version to a trace of the fail test input in the second code version and return a report of differences between the trace of the first test input in the second code version to the trace of the fail test input in the second code version; and
if there is not an input that makes the first path condition be true and the second path condition be false,
determining a second test input wherein the second test input is the path condition that makes the second path condition true and the first path condition false; and
comparing a trace of the second test input to a trace of the fail test input in the first code version and the second test input in the first code version and return a report of the differences between the trace of the second test input to the trace of the fail test input in the first code version and the second test input in the first code version.

10. The computer storage medium claim 9, further comprising computer executable code for using symbolic expression in the first code version and the second code version.

11. The computer storage medium of claim 10, wherein symbolic expression comprises
proceeding through a code section;
collecting all conditions in the code section into an expression; and
submitting the expression to the first code version or the second code version.

12. The computer storage medium of claim 11, wherein the condition is a branch in the code section.

13. The computer storage medium claim 9, wherein comparing the trace of the first test input in the second code version to the trace of the fail test input in the second code version returns a bug report at an assembly level that is reverse translated into a source level bug report for the second code version.

14. The computer storage medium of claim 13, wherein the source level bug report for the second code version comprises second code version code sections that should be reviewed for causing errors in the second code version.

15. The computer storage medium of claim 9, wherein comparing the trace of the second test input to the trace of the fail test input in the first code version and the second test input in the first code version returns a bug report at an assembly level that is reverse translated into a source level bug report for the first code version.

16. The computer storage medium of claim 15, wherein the source level bug report for the first code version comprises first code version code sections that should be reviewed for causing errors in the first code version.

17. A computer system comprising a processor physically configured according to computer executable instructions for determining error causing code sections between a first code version and a second code version, a memory for maintaining the computer executable instructions and an input/output circuit, the computer executable instructions comprising instructions for:
determining a fail test input (t) wherein the fail test input passes in the first code version and fails in the second code version;
determining a first path condition of the fail test input in the first code version wherein the first path condition captures a set of all inputs in the first code version which take the same path as that of the fail test input (t) in the first code version;
determining a second path condition of the fail test input in the second code version wherein the second path condition captures a set of all inputs in the second code version which take the same path as that of the fail test input (t) in the second code version;
determining whether a condition that the first path condition being true and a second path condition being false can be satisfied;
if there is an input that makes the first path condition be true and the second path condition be false,
determining a first test input wherein the first test input is a path condition that makes the first path condition true and the second path condition false; and
comparing a trace of the first test input in the second code version to a trace of the fail test input in the second code version and return a report of differences between the trace of the first test input in the second code version to the trace of the fail test input in the second code version; and
if there is not an input that makes the first path condition be true and the second path condition be false,
determining a second test input wherein the second test input is the path condition that makes the second path condition true and the first path condition false; and
comparing a trace of the second test input to a trace of the fail test input in the first code version and the second test input in the first code version and return a report of the differences between the trace of the second test input to the trace of the fail test input in the first code version and the second test input in the first code version.

18. The computer system of claim 17, the computer executable instructions comprising additional computer executable instructions for using symbolic expression in the first code version and the second code version, wherein symbolic expression comprises
proceeding through a code section;
collecting all conditions in the code section into an expression; and
submitting the expression to the first code version or the second code version.

19. The computer system of claim 17, wherein comparing the trace of the first test input in the second code version to the trace of the fail test input in the second code version returns a bug report at an assembly level that is reverse translated into a source level bug report for the second code version and wherein the source level bug report for the second code version comprises second code version code sections that should be reviewed for causing errors in the second code version.

20. The computer system of claim 17, wherein comparing the trace of the second test input to the trace of the fail test input in the second code version and the second test input in the first code version returns a bug report at an assembly level that is reverse translated into a source level bug report for the first code version and wherein the source level bug report for the first code version comprises second code version code sections that should be reviewed for causing errors in the first code version.
